(19) United States
(12) Patent Application Publication
(10) Pub. No.: US 2010/0118704 A1
(43) Pub. Date: May 13, 2010

(54) Method and Apparatus for use in a communications network

(76) Inventors: Gergely Pongracz, Budapest (HU); Daniel Krupp, Budapest (HU); Peter Vaderna, Budapest (HU)

Correspondence Address: ERICSSON INC., 6300 LEGACY DRIVE, M/S EVR 1-C-11, PLANO, TX, 75024, US

(21) Appl. No.: 12/445,048

(22) PCT Filed: Nov. 10, 2006
(86) PCT No.: PCT/EP2006/068357

§ 371 Date: Dec. 2, 2009

(30) Foreign Application Priority Data
Oct. 9, 2006 (EP) 2006-067204

(51) Int. Cl. H04L 12/26

(52) U.S. Cl. 370/235.1

(57) ABSTRACT

A method is provided of regulating a load placed on a first node of a telecommunications network caused by messages sent to the first node by a second node of the network according to a signalling protocol between the first node and the second node, comprising: using a leaky bucket restrictor associated with the second node to regulate the load, the leaky bucket having an adjustable leak rate; determining a roundtrip response delay relating to at least some of the messages during a measurement period; and adjusting the leak rate in dependence upon the determined response delay.

### BACKGROUND OF THE INVENTION

1. Field of the Invention

The present invention relates to a method and apparatus for use in a communications network.

2. Description of the Related Art

A Next Generation Network (NGN) is a packet-based network able to provide services including Telecommunication Services and able to make use of multiple broadband, QoS-enabled transport technologies and in which service-related functions are independent from underlying transport-related technologies. It offers unrestricted access by users to different service providers. It supports generalized mobility which will allow consistent and ubiquitous provision of services to users.

The IP Multimedia Subsystem (IMS) is a standardised control plane for the NGN architecture capable of handling Internet based multimedia-services defined by the European Telecommunications Standards Institute (ETSI) and the 3rd Generation Partnership Project (3GPP). IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. The IP Multimedia Subsystem (IMS) is a new subsystem added to the UMTS architecture in Release 5, for supporting traditional telephony as well as new multimedia services. Specific details of the operation of a UMTS communications network and of the various components within such a network can be found from the Technical Specifications for UMTS which are available from http://www.3gpp.org.

Different signalling and control protocols exist in Next Generation Networks and 3G mobile networks, with most processing carried out on the central processing unit (CPU) of the corresponding nodes.

Also, different types of nodes have different signal processing capacity. Controller nodes, like Media Gateway Controllers (also known as call servers or call agents) in NGN, or Mobile Switching Centers (MSCs) and Radio Network Controllers (RNCs) in Universal Mobile Telecommunications System (UMTS) networks, have significantly higher processing capacity than access nodes or media gateways. Because of that, there are scenarios where signalling overload in a specified access node caused by the controller node is likely.

Moreover in an NGN or in a UMTS network there is a possibility that there will be many nodes connected to a single controller. With such an architecture it is envisaged that it may only require a moderate increase in call attempt levels across all of the access nodes to cause a controller to become overloaded. In the case of media-stimulated events (e.g. tele-voting) or in the event of a disaster, there is often a large step change in the level of call attempts. Such an event is likely to severely overload the controllers to a level where service may cease completely.

Signalling overload causes the affected access node to respond with an increased delay. If overload continues, loss of messages or rejection will occur, and the access node's performance will degrade, or in the worst case the node will crash entirely. The access node is assumed to have an internal overload protection mechanism that is able to reject a part of the arriving stream of signalling messages in order to avoid a complete crash, but even in this case the access node throughput will drop if its processing capacity is significantly lower than the offered load. This is illustrated in FIG. 1, which shows access node behaviour in different load scenarios.

If the offered load is significantly higher than the capacity of the access node, the internal solution will not allow the access node to work with a high utilization and a quick response time. To improve the situation, the offered load can be controlled by an external load control function. It is desirable to provide such an external load control function that meets as many of the following requirements as possible:
To limit the processing delay of the signalling messages, caused mainly by the large number of buffered requests at the overloaded node.
To keep the access node in a stable state near its engineered capacity, while maintaining good resource utilization and throughput.
To share the controlled resource fairly between the users.

### SUMMARY OF THE INVENTION

According to a first aspect of the present invention there is provided a method of regulating a load placed on a first node of a telecommunications network caused by messages sent to the first node by a second node of the network according to a signalling protocol between the first node and the second node, comprising: using a leaky bucket restrictor associated with the second node to regulate the load, the leaky bucket having an adjustable leak rate; determining a roundtrip response delay relating to at least some of the messages during a measurement period; and adjusting the leak rate in dependence upon the determined response delay.

The method may comprise determining the number of or rate at which messages are delayed by more than a predetermined threshold during the measurement period.

Adjusting the leak rate may comprise determining whether the first node is in an overloaded condition.

Determining whether the first node is in an overloaded condition may be performed in dependence upon the number of or rate at which messages are delayed by more than the predetermined threshold during the measurement period.

Determining whether the first node is in an overloaded condition may comprise comparing the number of or rate at which messages are delayed by more than the predetermined threshold during the measurement period with a predetermined target number or rate.

Adjusting the leak rate may comprise, if it is determined that the first node is in an overloaded condition, determining whether the first node has entered the overloaded condition since it was previously determined whether the first node is in an overloaded condition, and if it is determined that the first node is not in an overloaded condition, determining whether the first node has left the overloaded condition since it was previously determined whether the first node is in an overloaded condition.

The method may comprise, if it is determined that the first node has entered the overloaded condition since it was previously determined whether the first node is in an overloaded condition, decreasing the leak rate.

The method may comprise, if it is determined that the first node has left the overloaded condition since it was previously determined whether the first node is in an overloaded condition, increasing the leak rate.

The method may comprise counting the number of consecutive adjustment steps performed in which it is not determined that the first node has entered or has left the overloaded condition, as the case may be, since it was previously determined whether the first node is in an overloaded condition.

The method may comprise adjusting the leak rate in dependence upon the count.

The method may comprise increasing or decreasing the leak rate by an amount proportional to 2^{count}.

The method may comprise adjusting the leak rate in dependence upon a response delay determined for a previous measurement period.

The method may comprise increasing the leak rate if it is determined that the response delay determined for the previous measurement period is greater than the present response delay by more than a predetermined amount.

The method may comprise decreasing the leak rate otherwise.

The method may comprise decreasing the leak rate by an amount less than a previous adjustment made to the leak rate.

The method may comprise decreasing the leak rate if it is determined that the present response delay is greater than the response delay determined for the previous measurement period by more than a predetermined amount.

The method may comprise increasing the leak rate otherwise.

The method may comprise increasing the leak rate by an amount less than a previous adjustment made to the leak rate.

The method may comprise adjusting the leak rate in dependence upon the response delay determined for the previous measurement period in such a manner only if it is not determined that the first node has entered or has left the overloaded condition, as the case may be, since it was previously determined whether the first node is in an overloaded condition.

The method may comprise adjusting the leak rate in dependence upon the fill of the leaky bucket.

The method may comprise not performing at least part of an adjustment step if it is determined that the fill of the leaky bucket is above a predetermined level.

The determined response delay may be an average response delay for the at least some messages during the measurement period.

The method may comprise adjusting the leak rate within predetermined bounds.

The method may comprise performing the adjusting step periodically.

Messages rejected by the leaky bucket restrictor may be dropped or queued in dependence upon the type of message.

The second node may be a controller node and the first node may be a controlled node.

The second node may be a master node and the first node may be a slave node.

The second node may be a gateway controller node and the first node may be a gateway node.

The signalling protocol may be a request-reply based signalling protocol.

The signalling protocol may be the H.248 protocol.

The signalling protocol may be the Q.2630 protocol.

The signalling protocol may be the Session Initiation Protocol, SIP.

The signalling protocol may be the Media Gateway Control Protocol.

The signalling protocol may be the Simple Gateway Control Protocol.

The signalling protocol may be the Internet Protocol Device Control.

The network may be a Next Generation Network.

The network may be a 3G Network.

The meaning and scope of the term “leaky bucket restrictor” will be well understood by a person skilled in the art. It should be interpreted broadly to cover all implementations of a leaky bucket type approach for controlling the rate at which traffic is sent to a network. An embodiment of the present invention may use a Type 2 Leaky Bucket restrictor for controlling the admitted traffic. This is a count that is decremented by (Now−TimeOfLastDecrement)×LeakRate at each call arrival instant (subject to not falling below 0). It is then incremented by SplashAmount if the count is less than or equal to the {MaximumFill−SplashAmount} and the call is admitted; otherwise the call is rejected and the count is not incremented. The maximum sustained admitted rate is LeakRate/SplashAmount. The LeakRate is adaptively changed by the overload control.

According to a second aspect of the present invention there is provided an apparatus for use as or in a second node of a telecommunications network, the apparatus comprising means for: using a leaky bucket restrictor to regulate a load placed on a first node of the network caused by messages sent to the first node by the second node according to a signalling protocol between the first node and the second node, the leaky bucket having an adjustable leak rate; determining a roundtrip response delay relating to at least some of the messages during a measurement period; and adjusting the leak rate in dependence upon the determined response delay.

According to a third aspect of the present invention there is provided a program for controlling an apparatus to perform a method according to the first aspect of the present invention or which, when loaded into an apparatus, causes the apparatus to become an apparatus according to the second aspect of the present invention.

The program may be carried on a carrier medium.

The carrier medium may be a storage medium.

The carrier medium may be a transmission medium.

According to a fourth aspect of the present invention there is provided an apparatus programmed by a program according to the third aspect of the present invention.

According to a fifth aspect of the present invention there is provided a storage medium containing a program according to the third aspect of the present invention.

### BRIEF DESCRIPTION OF THE DRAWINGS

FIG. 1, discussed hereinbefore, is a graph illustrating node behaviour in different load scenarios;

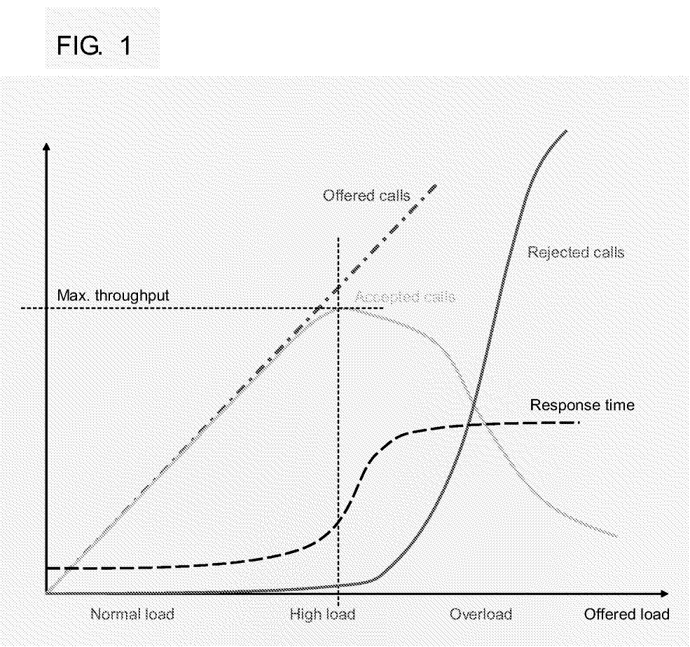

FIG. 2 illustrates one example of an operational environment to which an embodiment of the present invention can be applied: Next Generation Networks;

FIG. 3 illustrates another example of an operational environment to which an embodiment of the present invention can be applied: 3G networks;

FIG. 4 is a block diagram for explaining the context of a delay based overload control method according to an embodiment of the present invention;

FIG. 5 illustrates an overall state machine of a method embodying the present invention;

FIG. 6 is a flowchart illustrating a rate setting part of a method embodying the present invention;

FIG. 7 illustrates simulated results of using a rate control method according to an embodiment of the present invention in the case of fully controlled traffic; and

FIG. 8 illustrates simulated results of using a rate control method according to an embodiment of the present invention to show the sharing of available rate in the case of not fully controlled traffic.

### DETAILED DESCRIPTION OF THE PREFERRED EMBODIMENTS

As mentioned above, it is desirable to provide a function to control loads on an access node such as a Media Gateway. The following four separate approaches for controlling the load between unequally loaded entities have been previously considered.

Firstly, there is a drop and resend approach, which is perhaps the simplest way to limit response time on the overloaded node. With such an approach, signalling messages are dropped after a given buffer size, and resent later from the external node.

However, a disadvantage with the drop and resend approach is that dropping a signalling message results in high end-to-end delay from the subscriber's perspective. Moreover, it is very probable that there are a number of nodes needed to cooperate to create a voice call. If one node drops a message, the processing on other nodes may cause unnecessary load, or may block resources even they do not need to be blocked.

Secondly, there is a window-based approach, like the Transmission Control Protocol (TCP), in which the offered signalling rate is adapted to the rate of the reply messages. It is important that the reply can only be sent if the original message is fully processed. In the Service Specific Connection Oriented Protocol (SSCOP), the sender requests acknowledgements via a poll message and the receiver provides new credits with a reply.

However, a disadvantage with the window-based approach is that of granularity. The minimal window size is one message for the resource users. In case of lower capacity and/or large number of resource users, even a window of size one can cause high delay in the processing node. Moreover, the nodes have to maintain sequence numbers to send or acknowledge. Transmitting sequence numbers or credits requires the same protocol implemented on the receiver side. Q.2630 (also known as Q.AAL2: ITU-T recommendation Q.2630.3) can rely on SSCOP window mechanism but this protection is only valid on the SAAL layer (Signalling ATM Adaptation Layer) and the AAL2 layer (ATM Adaptation Layer) may still be overloaded. A matching between AAL2 processes and the SSCOP window is required on the peer node to use it for AAL2 signalling.

Thirdly, there is an overloaded entity controlled congestion handling approach (e.g. H.248.10; Media Gateway Resource Congestion Handling Package (H.248.10): ITU-T H.248 Annex M.2). In this approach, the overloaded entity calculates its real processing capacity and signals it to the connected external nodes. The explicit rate signalled by the overloaded entity is then applied in the external nodes thus decreasing the load. Regulation may use leaky bucket or percentage based rate control.

However, this explicit, H.248.10 like, notification approach has a disadvantage that an overloaded entity must take care of measuring its load, calculating its available capacity and signalling it to the non-overloaded entities. This causes even more load, while this notification has to be very fast and precise. Moreover, H.248.10 uses a percentage-based restrictor, where part of the incoming requests will pass the restrictor, causing bursts inside the system as well.

Finally, there is a congestion signal based approach (e.g. H.248.11; H.248.11 extension specification: ITU-T recommendation H.248.11). With this approach, the node signals an overload indication flag if it is overloaded. This flag is sent as a reply to every connection request, so the higher load an external node generates the higher rate of overload notifications it gets. Using this rate the external node can regulate its load using a leaky bucket restrictor.

However, a disadvantage with the congestion signal based approach is that the node also needs to monitor its load characteristics, and signal overload indication in case of overload. There are a huge number of overload notifications, these messages load each node, as they have to be generated on the overloaded node, and processed on the other end. The control is split into two nodes, and the far end node can only rely on the number of overload indication messages it gets, and nothing more.

Having appreciated and balanced the various advantages and disadvantages set out above, the applicant has devised an embodiment of the present invention as described in detail below. However, before a detailed description of an embodiment of the present invention, the basic concept underlying an embodiment of the present invention will first be described.

An embodiment of the present invention provides a Delay-based Overload Control (DOC) mechanism that uses round trip delay measurements as overload indication; it can be applied to control the load of request-reply based signalling protocols, for example the Session Initiation Protocol (SIP; see IETF RFC 3261), H.248 (see the H.248 v2 protocol specification: draft-ietf-megaco-h248v2-04.txt), and Q.2630 (also known as Q.AAL2 where AAL means ATM Adaptation Layer; see ITU-T recommendation Q.2630.3).

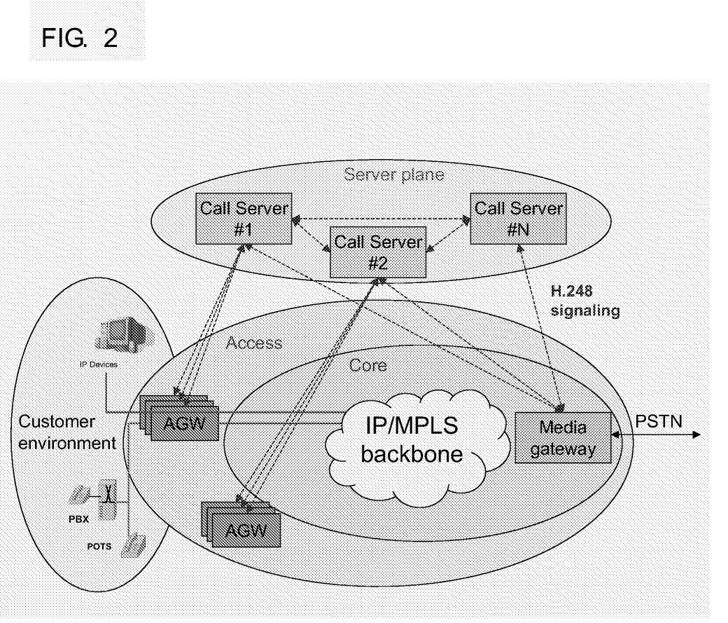

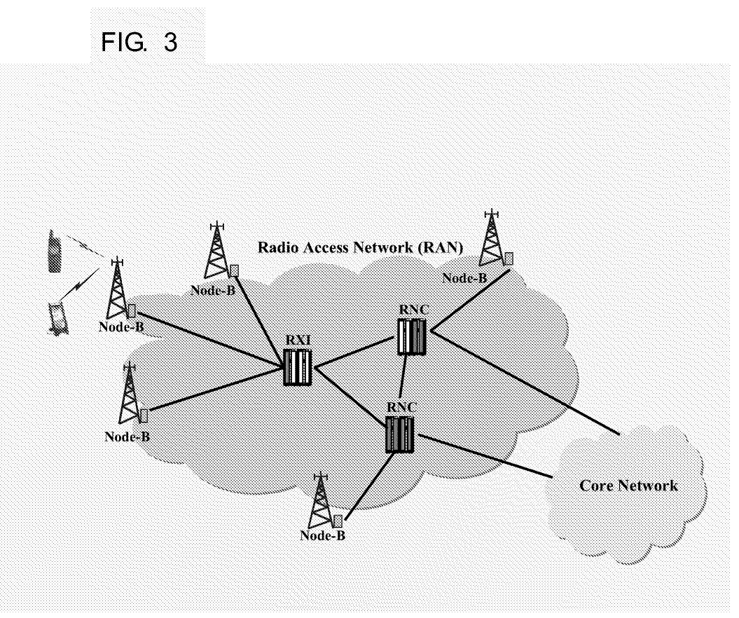

FIG. 2 and FIG. 3 illustrate example operation environments. In both cases, the node-node signalling can be controlled with a delay based overload control method embodying the present invention. In the case of NGN, the H.248 messages might be subject to control, while in the 3G case the Q.2630 messages might be subject to control.

Signalling overload can happen for the following reasons:
The signalling link is between nodes with different capacity. In this case the originator node should control its signalling rate. Examples are:
   Call server to access gateway (AGW) links (NGN)
   RNC to Node-B links (3G)
There are several nodes connected to one resource. In this case the control should guarantee that the central resource will not be overloaded. Examples are:
   AGW and call server to call server links (NGN)
   Node-B to RXI links (3G)
The above two reasons can also apply together, for example if several high capacity resource users are connected to a resource owner, like in the call server to media gateway (MGW) case.

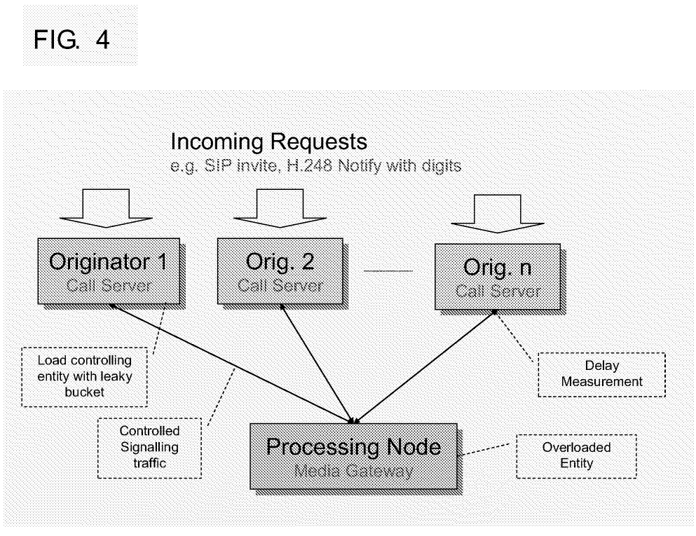

The following components of a load control algorithm embodying the invention are illustrated with reference to FIG. 4.

Firstly, the algorithm measures the response delay of reply messages on the originator nodes. It is not necessary to monitor the delay of every reply packets, but some minimal frequency would be required to reduce the variance of the measurement.

Secondly, the originator nodes use leaky bucket restrictors to control the amount of signalling load they send to the processing node. Traffic rejected by the leaky bucket can be dropped or queued, depending on the type of the message. For example, call setups could be rejected, while releases could be queued.

Thirdly, using the information gained from the delay measurement, the load control entity can adapt the leak rate periodically, thus finding the processing capacity of the resource server. This capacity may change in time, as there are other tasks consuming the common resource, so the dynamic behavior of the adaptation algorithm enables successful control.

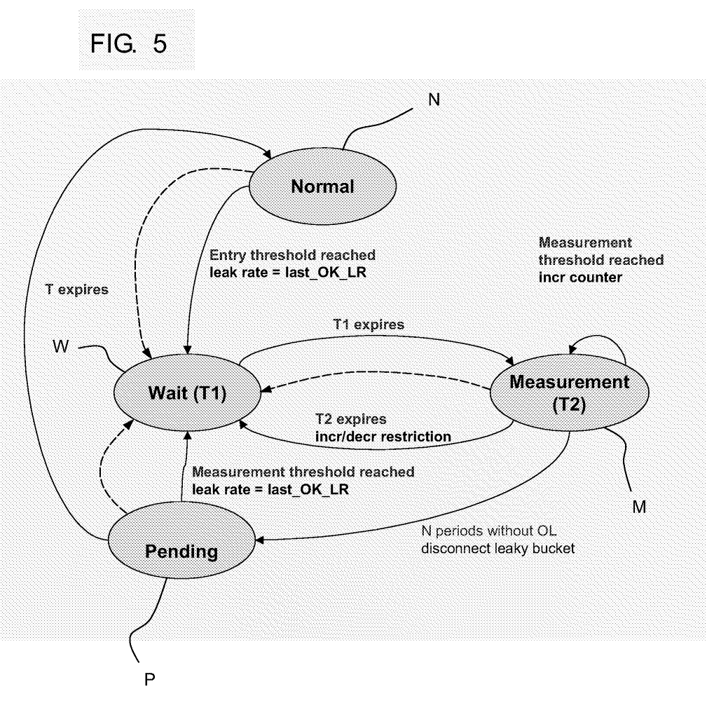

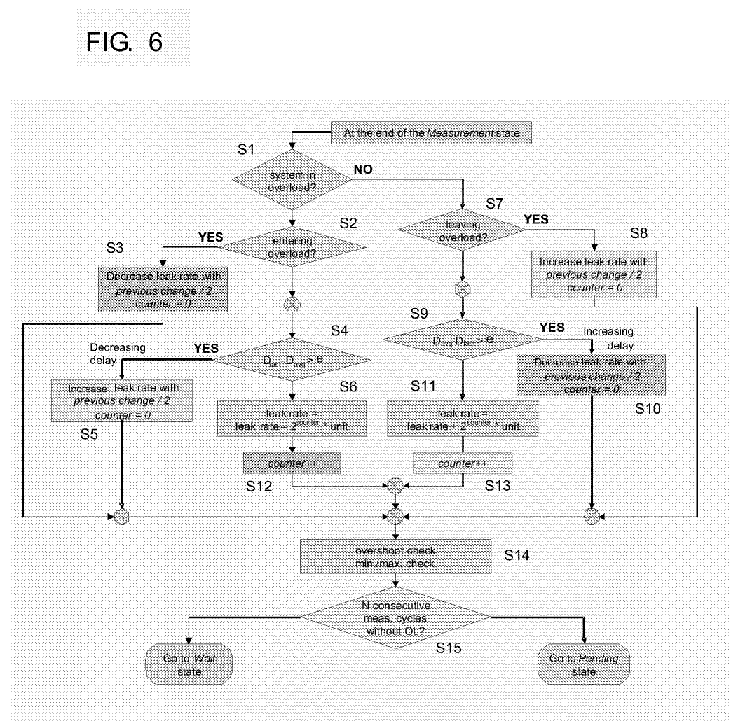

A more detailed description of an embodiment of the present invention will now be provided with reference to FIGS. 5 and 6. This embodiment introduces an algorithm running on the originator nodes, which is used to dynamically regulate the rate that requests are sent. A simple state machine with four states is used, and this is illustrated in FIG. 5. The state machine is described in detail below.

An important part of the algorithm is the rate setting routine that is performed when the algorithm finishes a measurement cycle and re-enters into the wait state. It has different stability criteria, and an overshoot protection mechanism. It changes the leak rate with an exponential function applied on the number of consecutive measurement cycles where the node was in the same state (overload, non-overload).

The algorithm controls the leak rate of a leaky bucket based on the roundtrip response delay of controllable requests, where the roundtrip response delay is the time it takes from sending a message to receiving a response, or some measure associated with or relating thereto. Controllable requests are the ones that can be dropped or queued because of load regulation, e.g. the ADD request in H.248 or ERQ in Q.2630. An example for non-controllable requests is the H.248 Modify request during a call setup, which has to be processed regardless of the load on the node, as the context on the gateway already exists.

Within the response delay, not only is the service time and the queuing delay included, but also the link delay that occurs on the links between the nodes. During the measurement state the algorithm counts those packets whose response delay was above a certain threshold (measurement threshold) and calculates the rate of these packets. At the end of the measurement period it computes the difference between the predefined target and the rate of delayed packets to decide whether the controlled node is in overload or not.

The operator specifies a target (delayed messages per second) for each protected node. This parameter plays an important role in the operation of the algorithm. At each controlling entity, the difference between the rate of the messages having a larger delay than the defined threshold and the overload target is calculated.

Calculating the leak rate adjustment value considering the rate of the number of delayed responses makes the leak rate setting sensitive to the actually generated rate of the originator nodes. An originator node which generates huge signalling traffic will get a large number of replies, so the rate of the reply packets which delay was more than the limit will be larger for such nodes than on originator nodes with smaller signalling traffic. This leads to a higher rate decrement on such nodes, while other nodes generating smaller traffic will decrease their leak rate with a smaller value, or even increase it.

This way the “max-min fairness” property of the algorithm is ensured. Max-min fairness is defined in the following way: A rate control is max-min fair if the leak rate (and the admitted call rate accordingly) of an originator node (lᵢ) can not be increased if it causes another node's leak rate (lⱼ) to drop, where lⱼ<lᵢ.

In a max-min fair environment originator node with high admission rate will not crowd out the other originator nodes in the long run.

Delay based overload control can be sensitive to the link delays occurring on the links between the controllers and the controlled node. However, in a non-congested transit network, link delay is usually much smaller than the typical measurement threshold, and the variance of it is minimal. Even if narrowband links are used, the delay is nearly constant. Knowing these constant delays, the operators can easily configure the algorithm's thresholds properly.

An overview of the state machine illustrated in FIG. 5 will now be provided, starting with the Normal state N.

In the Normal state N, the algorithm measures the response delay D of each transaction (or a number of transactions). If D>Dₑₜₕ, meaning the delay D of the packet was above an entry threshold Dₑₜₕ, then a state transition occurs to the Wait state W. The entry threshold should normally be higher than the measurement threshold, and should normally be high enough to prevent the algorithm from accidentally leaving the Normal state N.

Upon arriving at the Wait state W from the Normal state N, a timer T1 and the initial leak rate lᵢ is set. The initial leak rate is set to an initial leak rate value lᵢₙᵢₜ if the algorithm has not been run yet, otherwise lᵢ=lₒₖ, the last used leak rate, when no delayed transaction was seen. During the Wait state W no other action is taken.

When timer T1 expires, the algorithm enters into the Measurement state M. In this state, the response delay D of reply messages is checked, and if D>Dₘₜₕ, so if the delay D of a packet was above the measurement threshold Dₘₜₕ, then a delayed message counter is increased. Upon leaving the Measurement M state the rate of the packets with higher delay that Dₘₜₕ is calculated (the “overdelayed” rate).

After this calculation is done, the algorithm sets a new leak rate using the following parameters:
The calculated “overdelayed” rate.
The difference of the average response delay measured in the current and in the last measurement cycle.
The actual fill of the leaky bucket restrictor.

Calculation of the new leak rate will be described in more detail below. After setting the new leak rate, the algorithm decides the next state as follows.

If the number of consecutive measurement cycles in which no overload was detected exceeds a configured limit, the algorithm decides that the overload period is finished, and it jumps to the Pending state P.

In other cases the algorithm jumps back to Wait state W.

In the Pending state P, the algorithm measures the delay as in Normal state N, and if it is larger than the measurement threshold, it re-initializes the leaky bucket with the last leak rate where there was no overload and enters the Wait state W. After a period T in the Pending state without this occurring, the algorithm jumps back to the Normal state N. This state is only needed to avoid false turnoff of the algorithm when there is a short break in the overload period. However, it is reasonable to set the length of timer T to zero, thus effectively removing this state. A suggested value for T is 30-60 seconds.

For handling sudden changes in the node's processing performance, when the convergence of the algorithm would be too slow, a further high threshold Dₕₜₕ for the response delay is defined. When reaching this threshold Dₕₜₕ, the algorithm restarts in the Wait state W and applies the initial leak rate. This can happen in any state, and these asynchronous transitions are represented in FIG. 5 by dotted-line arrows.

In the rate setting algorithm, which will be described in more detail below with reference to FIG. 6, first the algorithm decides whether the system is in overload or not. After that the algorithm checks whether it is the first time in that state. In this case different actions are needed. Stability check is the following step. Here the average delay measured in the previous measurement cycle is checked, and the rate is adjusted if the difference is too large. At the end the algorithm the bucket fill check is executed, which means, that if the bucket is not nearly full (the restrictor is not restricting traffic), the rate of the restrictor should not be increased further.

The rate setting algorithm will now be described in detail with reference to FIG. 6. The following actions are taken at the end of the Measurement state M.

First the algorithm decides whether or not the node is in overload (step S1). This is done by comparing the delayed packet rate to the target rate set on the given originator node.

If the node is determined in step S1 to be in overload, the following actions are taken:
State change check: The algorithm checks (step S2) whether it just entered overload. If yes, it decreases the leak rate with the half of the last change, as it probably overshot the capacity (step S3). It also resets the counter in order to continue the rate setting with finer granularity and jumps to the bucket fill check (step S14).
Delay change check: The average response delay D_{avg} measured during the Measurement period M is compared to the last measured value Dₗₐₛₜ (step S4). If the delay has dropped more than a specified amount e (suggested: 10-20% of the measurement threshold) since the last measurement period, the leak rate is probably almost smaller than the capacity of the overloaded entity, so instead of decreasing it further, increase it with the half of the last change (step S5). The counter is also reset, allowing finer granularity in the following cycles. The algorithm continues at the bucket fill check (step S14).
Leak rate change: If the checks fail, the algorithm will change the leak rate (step S6) according to the following formula:

NewLeakRate=OldLeakRate−2^{counter}·unit
The unit is configurable. It is suggested to use a small value (5-10% of the splash amount), as it allows finer granularity. The exact value depends on the number of originator nodes, as the rate changes on the different nodes are cumulated.

On the other hand, when the processing node is determined in step S1 not to be in overload, the following actions are taken:
State change check: For the same reasons as in the above-described non-overload to overload transition, the algorithm increases the leak rate with the half of the last change and resets the counter (steps S7 and S8).
Delay change check: For stability reasons the algorithm checks the delay change similar to the overloaded state, and will decrease the leak rate and reset the counter if the delay increases (steps S9 and S10).
Leak rate change: Outside overload the algorithm will increase the leak rate according to the following formula (step S11):

NewLeakRate=OldLeakRate+2^{counter}·unit

After setting the new leak rate there are other actions that are common for both states:
Counter change: If the counter was not reset during the checks, it is increased to allow more aggressive rate change as the number of subsequent cycles in overload increases (steps S12 and S13).
Overshoot protection (bucket fill check): If the leaky bucket leak rate was previously not overly restrictive, the leak rate should not be increased. This could be checked, for example, by determining whether the leaky bucket is filled up to at least a configurable percent (suggested: 80%), or whether the bucket has rejected any transactions during the previous measurement period. If the bucket proved to be not overly restrictive, then the leak rate and the counter need not be changed. This check can be performed at any suitable time; in FIG. 6 it is shown as being performed in step S14, with any changes to the leak rate and counter in the present rate setting procedure being reversed depending on the result of the check. However, this check could also be performed elsewhere, such as between steps S7 and S9; in that case, depending on the result of the check, the procedure would pass either to step S11 or straight to a modified step S14 (min/max check). Moreover, there are other ways of checking whether or not the bucket is restricting traffic that would be readily apparent to the skilled person. This condition is evaluated to avoid leak rate increments if the restrictor is not really restricting traffic. It can happen that after a short peak, which causes the restrictor to switch on, there comes a period with moderate load. In this case, the leak rate might be increased further and further, regardless of the fact that there is no need to do that, because the actual rate is large enough. After such periods, if another burst comes, the rate might be too high, and the algorithm might not be able to decrease it fast enough to prevent a significant queue size to be built up on the protected node.
Min./Max. check: Configurable minimum and maximum values can be provided to limit the leak rate. These values are not mandatory, because the algorithm can operate work well with minimum set to zero, and maximum set to the processing capacity of the processing node. However, in some cases they can be useful. A check of the leak rate against the minimum and maximum values is performed in step S14.
Evaluating exit criteria: If the controlled node is not in overload, the algorithm checks the number of consecutive cycles in which the status has been the same (step S15). If this counter exceeds a configurable parameter (suggested value: 20-30), the leaky bucket is disconnected, and the algorithm enters the Pending state.

Simulation results were produced with the NS-2 simulator (The Network Simulator; see http://www.isi.edu/nsnam/ns/) and were used to illustrate the algorithm's behavior.

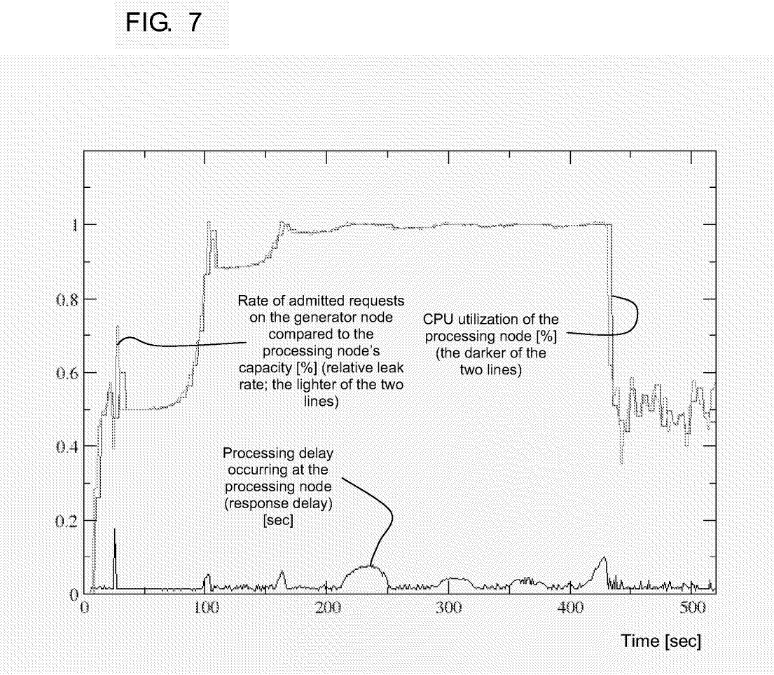

FIG. 7 illustrates the behavior of the algorithm in a simple case in which:
There was no uncontrolled signalling traffic on the node. Uncontrolled messages are typically release messages, that arrive after a given holding time, and can not be rejected by the controllers.
Single server—single queue model was used in the simulation.
Only a single node generated the load for the system under test.
The intensity of the generated requests was:
   50% of the processing node's capacity for 20 seconds
   1000% of the processing node's capacity from 20 to 420 seconds
   50% of the processing node's capacity from 420 to 520 seconds

FIG. 7 illustrates that the algorithm finds a stable state and after that runs with almost 100% utilization. As the external load is 1000% of the engineered capacity, 90% of the incoming requests are rejected, while the peak and the average delay are limited effectively. The first and second requirements mentioned above in the introductory description have been met.

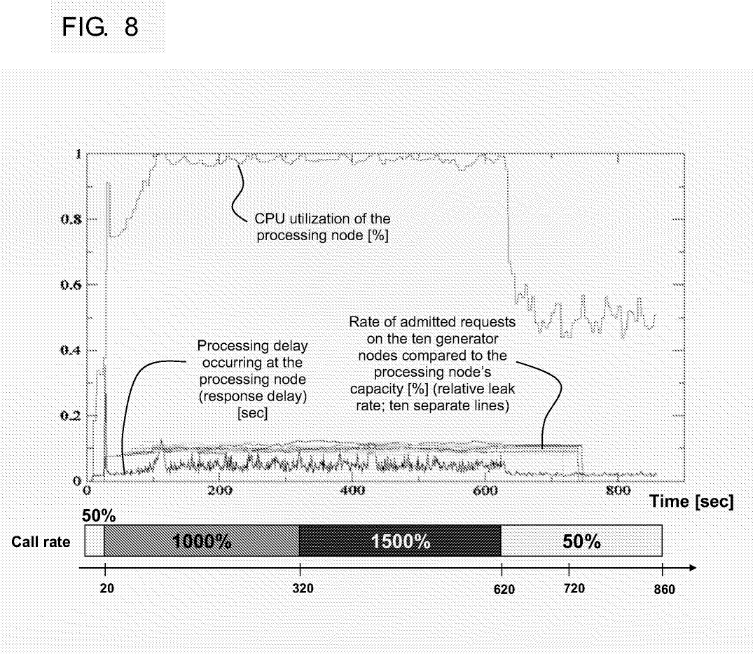

FIG. 8 illustrates a more complicated test case in which:
Ten generators were used to generate signalling load, so the fairness of the algorithm can be verified.
˜50% of the traffic was uncontrolled. Uncontrolled messages are typically release messages, that arrive after a given holding time, and can not be rejected by the controllers.
The intensity of the signalling traffic was varied in time. The intensity of the external requests is shown below the curves in FIG. 8 in proportion to the processing capacity of the overloaded entity.

FIG. 8 illustrates that in a normal situation, where there is some uncontrolled traffic, the algorithm runs effectively, limiting the peak and average delay, maximizing the utilization and sharing the resource fairly between the users. All three requirements mentioned above in the introductory description (limit delay, maximize utilization, fairness) have been met.

A method embodying the present invention can be used with a wide range of protocols that rely on a transaction-reply type of model. No internal knowledge of the controlled protocol is required; the overload protection just needs to measure the response time for a controlled transaction type. This kind of openness allows an algorithm embodying the present invention to co-operate with various other load control protocols, allowing it to be an effective emergency handling protection that starts working when there is a problem with the other protocols.

Although the algorithm was primarily developed for H.248 overload control, it will readily be appreciated that it can be adapted to other protocols as well, e.g. the AAL2 control protocol, the Q.2630, and so on.

A key advantage of an embodiment of the invention is its generality. There is no need of internal knowledge on the controlled protocol, no need for node performance measurements and external signalling, the algorithm just needs to measure the response time for controlled transactions.

Other advantages are as follows:
The control and the measurement are on the same (not overloaded) side. This means, that the controlling entity has the capacity of calculating the suitable rate, while the overloaded entity does not need to play an active role in the process. Because of this, the system's performance is optimal, as the overloaded entity processes only the real life signalling traffic, while the controller entity tries to find the capacity of the overloaded node by setting the leak rate.
Better overloaded entity performance: Because every measurement and rate calculation is done on the non-overloaded entity, the overloaded entity can process its backlog with its full capacity.
No need of external signalling (e.g. overload indication generation): from a performance point of view, avoiding any unnecessary signalling message is a gain. In an embodiment of the invention there is only passive monitoring, so no new messages and their processing methods are needed.
Able to guarantee small delay in such setups, where the processing resource is shared among many originator nodes: this fine granularity of control is the method's main advantage over window based solutions.

These advantages make an embodiment of the present invention an ideal candidate as a general overload protection solution for different request-reply protocols, or as an emergency solution over different other load control protocols.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A method of regulating a load placed on a first node of a telecommunications network caused by messages sent to the first node by a second node of the network according to a signalling protocol between the first node and the second node, the method comprising:
using a leaky bucket restrictor associated with the second node to regulate the load, the leaky bucket having an adjustable leak rate;
determining a roundtrip response delay relating to at least some of the messages during a measurement period; and
adjusting the leak rate in dependence upon the determined response delay, wherein determining the roundtrip response delay comprises determining the number of, or rate at which, messages are delayed by more than a predetermined threshold during the measurement period.

2. The method as claimed in claim 1, wherein adjusting the leak rate comprises determining whether the first node is in an overloaded condition.

3. The method as claimed in claim 2, wherein determining whether the first node is in an overloaded condition is performed in dependence upon the number of or rate at which messages are delayed by more than the predetermined threshold during the measurement period.

4. The method as claimed in claim 3, wherein determining whether the first node is in an overloaded condition comprises comparing the number of, or rate at which, messages are delayed by more than the predetermined threshold during the measurement period with a predetermined target number or rate.

5. The method as claimed in claim 2, wherein adjusting the leak rate comprises,
if it is determined that the first node is in an overloaded condition, determining whether the first node has entered the overloaded condition since it was previously determined whether the first node is in an overloaded condition, and
if it is determined that the first node is not in an overloaded condition, determining whether the first node has left the overloaded condition since it was previously determined whether the first node is in an overloaded condition.

6. The method as claimed in claim 5, comprising,
if it is determined that the first node has entered the overloaded condition since it was previously determined whether the first node is in an overloaded condition, decreasing the leak rate.

7. The method as claimed in claim 5, comprising,
if it is determined that the first node has left the overloaded condition since it was previously determined whether the first node is in an overloaded condition, increasing the leak rate.

8. The method as claimed in claim 5, comprising
counting the number of consecutive adjustment steps performed in which it is not determined that the first node has entered or has left the overloaded condition, as the case may be, since it was previously determined whether the first node is in an overloaded condition.

9. The method as claimed in claim 8, comprising adjusting the leak rate in dependence upon the count.

10. The method as claimed in claim 9, comprising increasing or decreasing the leak rate by an amount proportional to 2^{count}.

11. The method as claimed in claim 1, comprising adjusting the leak rate in dependence upon a response delay determined for a previous measurement period.

12. The method as claimed in claim 11, comprising increasing the leak rate if it is determined that the response delay determined for the previous measurement period is greater than the present response delay by more than a predetermined amount.

13. The method as claimed in claim 12, comprising decreasing the leak rate if it is determined that the response delay determined for the previous measurement period is not greater than the present response delay by more than a predetermined amount

14. The method as claimed in claim 6, comprising decreasing the leak rate by an amount less than a previous adjustment made to the leak rate.

15. The method as claimed in claim 11, comprising decreasing the leak rate if it is determined that the present response delay is greater than the response delay determined for the previous measurement period by more than a predetermined amount.

16. A method as claimed in claim 15, comprising increasing the leak rate if it is determined that the present response delay is greater than the response delay determined for the previous measurement period by more than a predetermined amount.

17. The method as claimed in claim 7, comprising increasing the leak rate by an amount less than a previous adjustment made to the leak rate.

18. The method as claimed in claim 11, comprising
adjusting the leak rate in dependence upon the response delay determined for the previous measurement period only if it is not determined that the first node has entered or has left the overloaded condition since it was previously determined whether the first node is in an overloaded condition.

19. The method as claimed in claim 1, comprising adjusting the leak rate in dependence upon the fill of the leaky bucket.

20. The method as claimed in claim 1 comprising not performing an adjustment step if it is determined that the fill of the leaky bucket is above a predetermined level.

21. The method as claimed in claim 1, wherein the determined response delay is an average response delay for the at least some messages during the measurement period.

22. The method as claimed in claim 1, comprising adjusting the leak rate within predetermined bounds.

23. The method as claimed in claim 1, comprising performing the adjusting step periodically.

24. The method as claimed in claim 1, wherein messages rejected by the leaky bucket restrictor are dropped or queued in dependence upon the type of message.

25. The method as claimed in claim 1, wherein the second node is a controller node and the first node is a controlled node.

26. The method as claimed in claim 1, wherein the second node is a master node and the first node is a slave node.

27. The method as claimed in claim 1, wherein the second node is a gateway controller node and the first node is a gateway node.

28. The method as claimed in claim 1, wherein the predetermined threshold is associated with the first node.

29. The method as claimed in claim 1, wherein the signalling protocol is a request-reply based signalling protocol.

30. The method as claimed in claim 1, wherein the signalling protocol is the H.248 protocol.

31. The method as claimed in claim 1, wherein the signalling protocol is the Q.2630 protocol.

32. The method as claimed in claim 1, wherein the signalling protocol is the Session Initiation Protocol, SIP.

33. The method as claimed in claim 1, wherein the signalling protocol is the Media Gateway Control Protocol.

34. The method as claimed in claim 1, wherein the signalling protocol is the Simple Gateway Control Protocol.

35. The method as claimed in claim 1, wherein the signalling protocol is the Internet Protocol Device Control.

36. The method as claimed in claim 1, wherein the network is a Next Generation Network.

37. The method as claimed in claim 1, wherein the network is a 3G Network.

38. An apparatus for use as, or in, a second node of a telecommunications network, the apparatus comprising means for:
using a leaky bucket restrictor to regulate a load placed on a first node of the network caused by messages sent to the first node by the second node according to a signalling protocol between the first node and the second node, the leaky bucket having an adjustable leak rate;
determining a roundtrip response delay relating to at least some of the messages during a measurement period; and
adjusting the leak rate in dependence upon the determined response delay.

39-40. (canceled)
